(19) United States
(12) Patent Application Publication
(10) Pub. No.: US 2018/0172914 A1
(43) Pub. Date: Jun. 21, 2018

(54) OPTICAL FIBER WITH THIN FILM COATING AND CONNECTOR

(71) Applicant: 3M INNOVATIVE PROPERTIES COMPANY, St. Paul, MN (US)

(72) Inventors: Daniel J. Treadwell, Austin, TX (US); Donald K. Larson, Cedar Park, TX (US); Ding Wang, Austin, TX (US); William J. Clatanoff, Austin, TX (US); Manfred Bauer, Wuppertal (DE); Johannes Fink, Bergheim (DE)

(21) Appl. No.: 15/579,658

(22) PCT Filed: May 5, 2016
(86) PCT No.: PCT/US16/30890

§ 371 Date: Dec. 5, 2017

Related U.S. Application Data
(60) Provisional application No. 62/174,719, filed on Jun. 12, 2015.

(51) Int. Cl. G02B 6/293; G02B 6/255; G02B 6/38

(52) U.S. Cl. CPC G02B 6/29368; G02B 6/2553; H04B 10/27; G02B 6/3887; G02B 6/3893; G02B 6/3846

(57) ABSTRACT

An article comprises an optical fiber having a first end with a first end surface having a deposited coating only on a portion thereon. The first end can have a frustoconic or tronconic shape. The optical fiber can be utilized as a stub fiber in an optical device, such as an optical connector, receptacle or adapter. The deposited coating can be a wavelength selective multilayer thin film coating. The deposited coating can reflect a selected wavelength of light back to a central office to provide monitoring in a communication network, such as a PON.

### BACKGROUND

### Field of the Invention

The present invention is directed to an article that includes an optical fiber, in particular, an optical fiber having a deposited coating on a portion of an end surface.

### Related Art

Many of today's copper access networks are being replaced by fiber networks in order to meet the ever increasing demand of bandwidth. Monitoring of these fiber networks is essential in order to assure quality of service and allow common use of one network by different service providers.

The expansion of passive optical networks (PON), where the signal on a single optical fiber is split into separate fibers to run to each subscriber, has triggered the need for cost-effective testing. One technique for testing fiber optic links from a remote location is to send a signal down the fiber and observe the reflective events. For example, an established method for this task is the so-called OTDR technology which uses a test head in the central office and test reflectors at each customer premise. To prevent the interruption of service, light whose wavelength is different from that of the communication light is used for testing. In a single fiber, the time of flight and reflected power provides information about the quality of the fiber path. In a PON system the light is split and travels independently down each branch. The resulting back-reflected light is a conglomeration of all the legs and analyzing the quality of the individual transmission lines is difficult.

There are conventional reflector solutions that can either be implemented inside an optical connector or used as a stand-alone component. One type uses fiber Bragg gratings. Alternatively thin film filter solutions are described in which discrete filter elements are inserted in the optical path. For example, see U.S. Pat. No. 5,037,180; JP 11231139; and EP 2264420. However these solutions have the disadvantage of being cost intensive due to complex production processes. Since one reflector per connected household is needed and the extent of FTTH deployment is increasing rapidly, cost effective reflectors are needed.

### SUMMARY

According to a first aspect of the present invention, an article comprises an optical fiber having a first end with a first end surface having a deposited coating only on a portion thereon. In another aspect, the first end can have a frustoconic or tronconic shape. In another aspect, the optical fiber can be utilized as a stub fiber in an optical device, such as an optical connector. In another aspect, the deposited coating can be a wavelength selective multilayer thin film coating. In another aspect, the deposited coating can reflect a selected wavelength of light back to a central office to provide monitoring in a communication network, such as a PON.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is a side view and FIG. 1B is an isometric view of an optical fiber according to a first aspect of the invention.

FIG. 2A is a side view and FIG. 2B is an isometric view of an optical fiber according to another aspect of the invention.

FIG. 3 is a side view of an optical fiber according to another aspect of the invention.

FIG. 4 is a side view of an optical fiber according to another aspect of the invention.

FIG. 5A is a side view and FIG. 5B is an isometric view of an optical fiber according to another aspect of the invention.

FIG. 6 is an isometric view of an optical connector according to another aspect of the invention.

FIG. 7 is an exploded view of the optical connector of FIG. 6 according to another aspect of the invention.

FIG. 8 is cross-section view of the optical connector of claim 6.

FIG. 9 is another cross-section view of the optical connector of claim 6.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention.

The present invention is directed to an article that comprises an optical fiber having a thin film wavelength selective filter coating on an end surface of the fiber. According to an aspect of the invention, the optical fiber with the thin film filter coating can be integrated into an optical device, such as an optical fiber connector, receptacle or adapter. For example, the optical fiber having a wavelength selective filter coating can be integrated into a field mountable optical connector. In particular, the optical fiber and connector of the exemplary embodiments can be of compact length and can be capable of straightforward field termination. The exemplary connector(s) described herein can be readily installed and utilized for Fiber To The Home (FTTH) and/or Fiber To The X (FTTX) network installations.

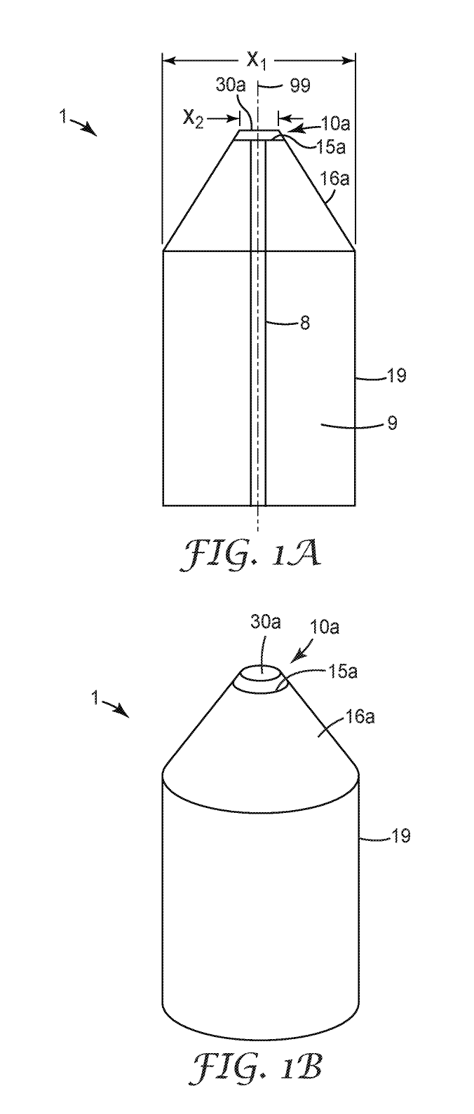

FIGS. 1A and 1B show a first aspect of the invention, an article that comprises an optical fiber 1 having a shaped end surface 10a. The optical fiber 1 can be a conventional optical fiber, such as those described herein, having a glass core 8 and cladding 9. Optical fiber 1 can be a single mode or multimode fiber. The outer diameter X₁ can be a standard size, such as 125 μm. Of course, an outer protective buffer or jacket can be disposed on the outer diameter 19 of fiber 1. When implemented as a stub fiber, however, the protective buffer or coating is removed as the optical fiber is typically secured in a ferrule. As such, FIGS. 1A and 1B depict the glass portion of the optical fiber.

In particular, in this aspect, end surface 10a has a frustoconic or tronconic shape (e.g., where the end surface 10a is shaped like the end of a pencil). As such, the end surface 10a can comprise multiple surfaces, such as tip surface 15a and radial side surface 16a, which is tapered at an angle with respect to the optical axis 99. For example, the taper angle can be from about 10 degrees to about 30 degrees with respect to optical axis 99. In another aspect, the taper angle can be from about 15 degrees to about 25 degrees with respect to optical axis 99. The radial side surface 16a can be formed using an etching, grinding, polishing or ablation process to create the tapered shape. In one aspect, radial side surface 16a can be a continuous surface. Alternatively, radial side surface 16a can include a plurality of side surfaces or facets.

In addition, tip surface 15a is shown to be substantially perpendicular to optical axis, and can have a tip surface diameter of X₂, which can be from about 0.45X₁ to about 0.8X₁. In addition, a portion of end surface 10a is covered by a coating 30a. In particular, only a portion of end surface 10a (such as tip surface 15a) is covered by coating 30a, leaving at least some portion of radial side surface 16a uncovered by coating 30a.

In an aspect of the invention, coating 30a comprises a wavelength selective filter coating. In this regard, the coating can be designed to pass/transmit certain wavelengths of light (e.g., light having a wavelength of between 1260 nm to about 1620 nm) and reflect another wavelength of light (e.g, light having a wavelength of about 1640 nm to about 1690 nm). The transmission and reflection characteristics of the in-band and out-of-band regions are preferably specified and controlled for proper system performance. For example, the IEC 61753-041-2 standard describes optical characteristics of a filter used in a PON monitoring system. In the reflection requirements for this standard, there are two grades—S (return loss better than 26 dB) and T (return loss better than 35 dB).

In an alternative aspect, the wavelength selective filter coating can simply be designed to pass certain wavelengths and block transmission of different wavelengths downstream. The wavelength selective filter coating can comprise a multilayer optical coating that can be deposited onto a portion of the end surface 10a. In one aspect, the deposited coating is substantially uniform on the coated portion of the end surface 10a. As discussed in more detail below, optical fiber 1 can be utilized as a stub fiber in an optical fiber connector, in particular, a fiber stub protruding from a ferrule portion of the optical fiber connector towards an interior region of the connector. This configuration combines connectivity and a test reflector in a single low cost device without having to significantly modify the design of an existing connector.

Coating 30a can be deposited using a thin film vapor deposition or plasma coating process. In one aspect, the process can include coating multiple optical fiber end surfaces at the same time. Areas where the coating is undesirable can be shielded or masked to prevent the coating from attaching to the object (fiber).

If implementing the optical fiber as a fiber stub, the end surface of the fiber can protrude slightly above the mask surface during the deposition process. When the wavelength selective filter coating is applied, the outside diameter of the glass portion of the fiber is uncoated and unchanged. The fiber can be placed at the same height as the mask and the coating will not bridge from the mask to the fiber creating a continuous surface. After coating, the mask can be removed leaving coating on the tip surface, but not on the radial side surface. This fiber tip configuration allows for less accurate placement of a mask during the coating process.

Alternatively, a coating 30a can be deposited on a full fiber end surface. Then an etching, grinding, polishing or ablation process can be used to create the tapered radial side walls up to the tip surface by removing portions of the glass cladding (and deposited coating) at a desired taper angle. In that manner, coating 30a remains only on tip surface 15a.

The multilayer wavelength selective coating 30a can comprise a low pass thin-film interference filter capable of meeting an out-of-band reflection specification of 35 dB, and includes a plurality of layers, with precise thickness control of each layer. With this configuration, when utilized as a reflective filter in an optical network, the slightly angled/tapered end surface 10a of the fiber stub results in a portion of the reflected light being sent into the cladding 9, thereby improving the reflection performance. When implemented in a communications network, such as a PON, adding a filter in front of the subscriber's home that reflects only the test light provides an event that is easily distinguished after the splitter. Such a filter can be integrated into a field installed connector during the installation process providing a well-defined event for the link analysis. Testing a transmission line using a reflective filter on the end can be performed from a remote maintenance center. This configuration enables the isolation of fiber faults, reducing maintenance costs and improving service reliability.

As described in more detail below, a field terminated optical fiber connector can include a factory-polished ceramic ferrule, fiber stub, and a field fiber aligned by a mechanical splice. For example, U.S. Pat. No. 7,369,738 (incorporated by reference herein in its entirety) describes an optical fiber connector that includes a pre-polished fiber stub disposed in ferrule that is spliced to a field fiber with a mechanical splice. Such a connector, called an NPC, is commercially available through 3M Company (St. Paul, Minn.). Some mechanical splice devices include a metallic splice element with a precise v-groove feature, which upon actuation, brings the field and factory (stub) fibers into alignment clamping and locking. The optical fiber design described herein can help reduce the likelihood of lateral offset between the fibers when seated in the v-groove, where such lateral offset can result in optical losses. If the coating process used to apply a multilayer film is not properly controlled, the coating process can coat all exposed surfaces. Non-uniform coating on the sides of the fiber stub can prevent good fiber alignment in a mechanical splice. This frustoconic or tronconic end surface shaping provides for more tolerance in the masking process. The fiber end surface shape allows for the multilayer coating to reside substantially only on the tip surface of fiber stub allowing for proper alignment in a mechanical splice joint.

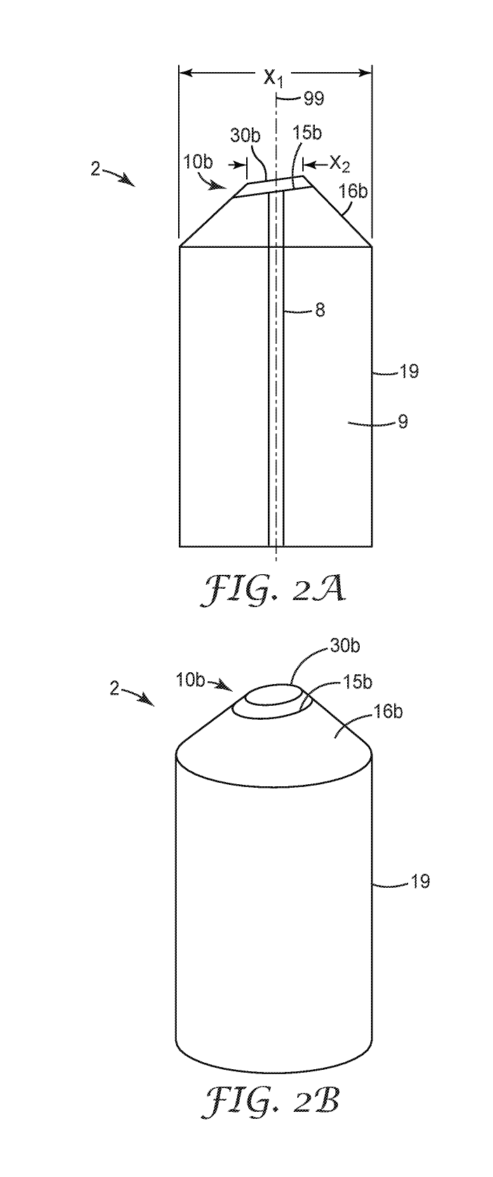

FIGS. 2A and 2B show another aspect of the invention, an article that comprises an optical fiber 2 having a shaped end surface 10b. The optical fiber 2 can be a conventional optical fiber, such as those described herein, having a glass core 8 and cladding 9. Optical fiber 2 can be a single mode or multimode fiber. The outer diameter X₁ can be a standard size, such as 125 μm.

In particular, in this aspect, end surface 10b has a tronconic shape, with a tip surface 15b and radial side surface 16b, which is tapered at an angle with respect to the optical axis 99. For example, the taper angle can be from about 10 degrees to about 30 degrees with respect to optical axis 99. In another aspect, the taper angle can be from about 15 degrees to about 25 degrees with respect to optical axis 99. The radial side surface 16b can be formed using an etching, grinding, polishing or ablation process to create the tapered shape. In addition, unlike fiber 1, the tip surface 15b of fiber 2 is slightly angled with respect to the plane perpendicular to the fiber axis 99. In one aspect, the angle is from greater than 0 degrees to about 10 degrees with respect to the plane perpendicular to the fiber axis 99. Also, tip surface 15b can have a tip surface diameter of X₂, which can be from about 0.45X₁ to about 0.8X₁. In addition, a portion of end surface 10b is covered by a coating 30b. In particular, only a portion of end surface 10b is covered by coating 30b, leaving some portion of radial side surface 16b uncovered by coating 30b.

In an aspect of the invention, coating 30b comprises a wavelength selective coating such as that described above. The coating 30b can be deposited on end surface 10b in a manner similar to that described above. Fiber 2 can be implemented as a fiber stub in an optical fiber connector as described further herein.

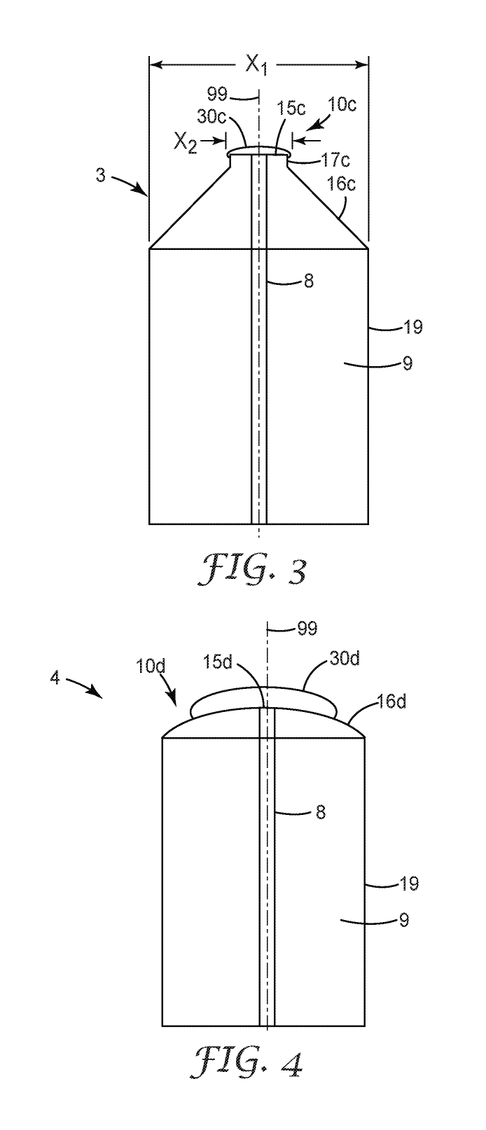

FIG. 3 shows another aspect of the invention, an article that comprises an optical fiber 3 having a shaped end surface 10c. The optical fiber 3 can be a conventional optical fiber, such as those described herein, having a glass core 8 and cladding 9. Optical fiber 3 can be a single mode or multimode fiber. The outer diameter X₁ can be a standard size, such as 125 μm.

In particular, in this aspect, end surface 10c has a modified frustoconic or tronconic shape, with a tip surface 15c, first radial side surface 16c, which is tapered at an angle with respect to the optical axis 99, and second side surface 17c, which is parallel to the optical axis 99. The taper angle of first side surface 16c can be from about 10 degrees to about 30 degrees with respect to optical axis 99. In another aspect, the taper angle can be from about 15 degrees to about 25 degrees with respect to optical axis 99. The radial side surface 16c can be formed using an etching, grinding, polishing or ablation process to create the tapered shape. In addition, the tip surface 15c of fiber 3 can be substantially perpendicular to the optical axis 99 (such as shown in FIG. 3) or it can be slightly angled with respect to the plane perpendicular to the fiber axis 99 (similar to surface 15b shown in FIGS. 2A and 2B). Also, tip surface 15c can have a tip surface diameter of X₂, which can be from about 0.45X₁ to about 0.8X₁. In addition, a portion of end surface 10c is covered by a coating 30c. In particular, only a portion of end surface 10c is covered by coating 30c, leaving at least some portion of radial side surface 16c uncovered by coating 30c.

In an aspect of the invention, coating 30c comprises a wavelength selective coating such as that described above. The coating 30c can be deposited on end surface 10c in a manner similar to that described above. Fiber 3 can be implemented as a fiber stub in an optical fiber connector as described further herein.

FIG. 4 shows another aspect of the invention, an article that comprises an optical fiber 4 having a shaped end surface 10d. The optical fiber 4 can be a conventional optical fiber, such as those described herein, having a glass core 8 and cladding 9. Optical fiber 4 can be a single mode or multimode fiber. The outer diameter X₁ can be a standard size, such as 125 μm.

In particular, in this aspect, end surface 10d has a rounded shape, with a tip surface 15d and a rounded radial side surface 16d. The rounded radial side surface 16d can be formed using a polishing, arc, or laser finishing process. In addition, the tip surface 15d of fiber 4 can be substantially perpendicular to the optical axis 99, it can be slightly angled with respect to the plane perpendicular to the fiber axis 99 (similar to surface 15b shown in FIGS. 2A and 2B), or it can have a rounded (substantially non-flat) shape. In addition, a portion of end surface 10d is covered by a coating 30d. In particular, only a portion of end surface 10d is covered by coating 30d, leaving at least some portion of radial side surface 16d uncovered by coating 30d.

In an aspect of the invention, coating 30d comprises a wavelength selective coating such as those described above. The coating 30d can be deposited on end surface 10d in a manner similar to that described above. Fiber 3 can be implemented as a fiber stub in an optical fiber connector as described further herein.

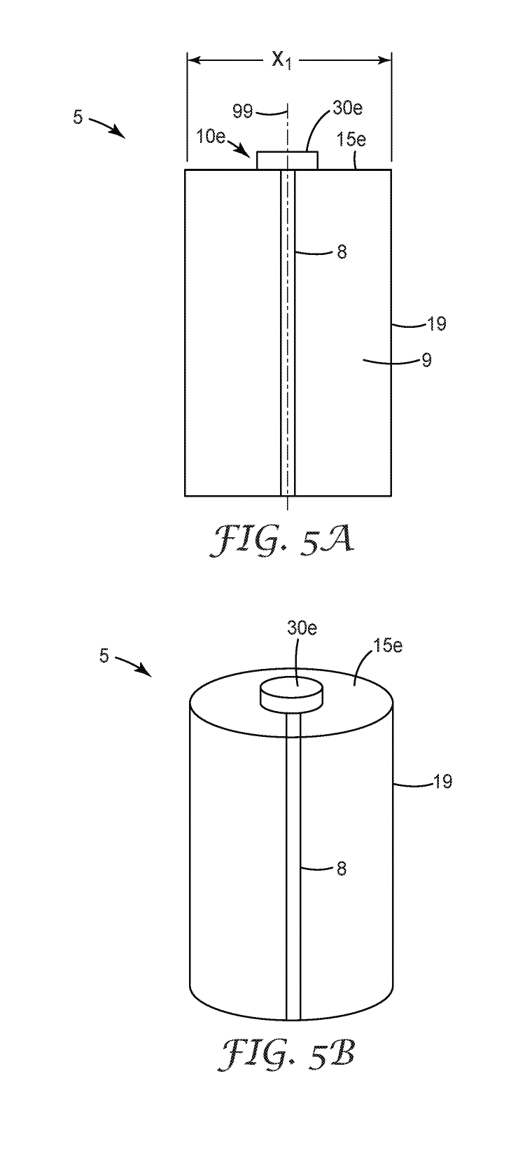

FIGS. 5A and 5B show another aspect of the invention, an article that comprises an optical fiber 5 having a flat end surface 10e, where tip surface 15e can be substantially perpendicular to the optical axis 99 (as shown in FIGS. 5A and 5B) or it can be slightly angled with respect to a plane perpendicular to the optical axis 99. The optical fiber 5 can be a conventional optical fiber, such as those described herein, having a glass core 8 and cladding 9. Optical fiber 5 can be a single mode or multimode fiber. The outer diameter X₁ can be a standard size, such as 125 μm.

In particular, in this aspect, end surface 10e is partially covered by a deposited coating 30e. In this aspect of the invention, coating 30e comprises a wavelength selective coating such as those described above. The coating 30e can be also deposited on end surface 10e in the following alternative manner. A positive photoresist, such as a conventional photoresist material, can be applied to surface 15e. Activating light can be shone through fiber core 8. The photoresist can be developed, then cleaned (e.g., by plasma etching), thereby removing the exposed photoresist. The wavelength selective multilayer coating can then be deposited onto the fiber end surface 10e. Then the remaining photoresist is stripped, leaving a deposited coating 30e covering only a portion of end surface 10e. Alternatively, a coating process using an external mask can be utilized. Alternatively, an external mask can be used to image the photoresist.

For a single mode fiber, the diameter of coating 30e can be from about two times the core diameter to about 0.8 X₁. For a multimode fiber, diameter of coating 30e can be from about 1.2 times the core diameter to about 0.8 X₁. Fiber 5 can be implemented as a fiber stub in an optical fiber connector as described further herein.

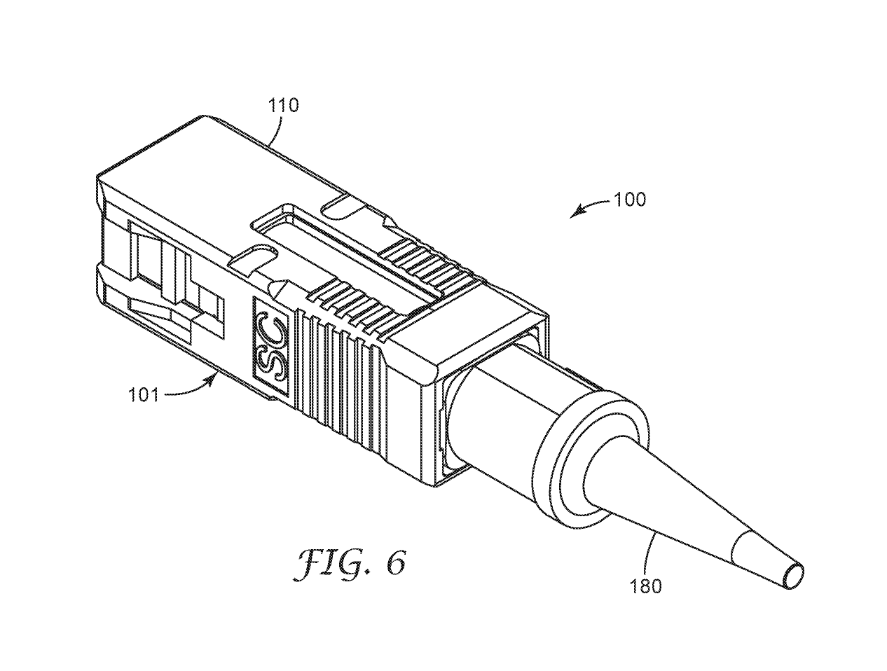

As mentioned above, the optical fibers 1-5 can each be integrated in an optical device, such as an optical connector, receptacle or adapter. For example, in one aspect, the optical fibers 1-5 can be used as stub fibers in a field terminable optical fiber connector, such as an NPC optical connector. FIGS. 6-9 show such an exemplary optical connector. Please note that as shown in FIG. 6, exemplary optical connector 100 is configured as having an SC format. However, as would be apparent to one of ordinary skill in the art given the present description, optical connectors having other standard formats, such as ST, FC, and LC connector formats can also be provided.

SC-type optical fiber connector 100 can include a connector body 101 having a housing 110 and a fiber boot 180. In this exemplary embodiment, housing 110 includes an outer shell 112, configured to be received in an SC receptacle (e.g., an SC coupling, an SC adapter, or an SC socket), and a backbone 116 that is housed inside the shell 112 and that provides structural support for the connector 100. In addition, backbone 116 further includes at least one access opening 117, which can provide access to actuate a mechanical splice disposed within the connector. Backbone 116 can further include a mounting structure 118 that provides for coupling to the fiber boot 180, which can be utilized to protect the optical fiber from bend related stress losses. According to an exemplary embodiment of the present invention, shell 112 and backbone 116 are formed or molded from a polymer material, although metal and other suitably rigid materials can also be utilized. Shell 112 is preferably secured to an outer surface of backbone 116 via snap fit.

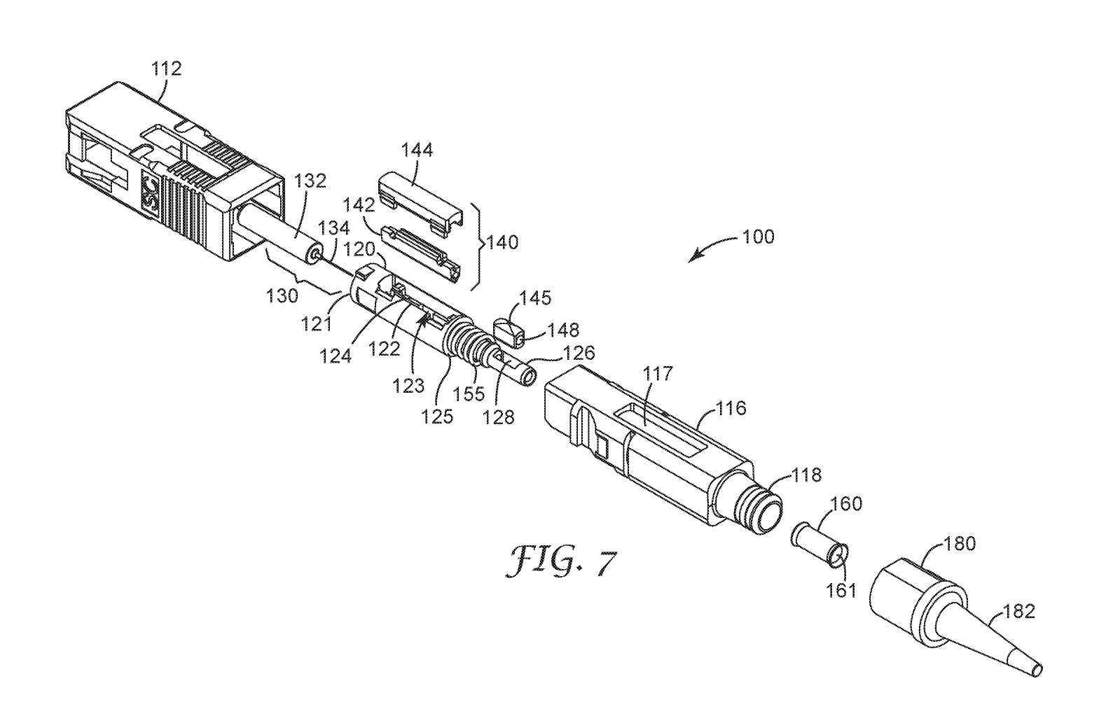

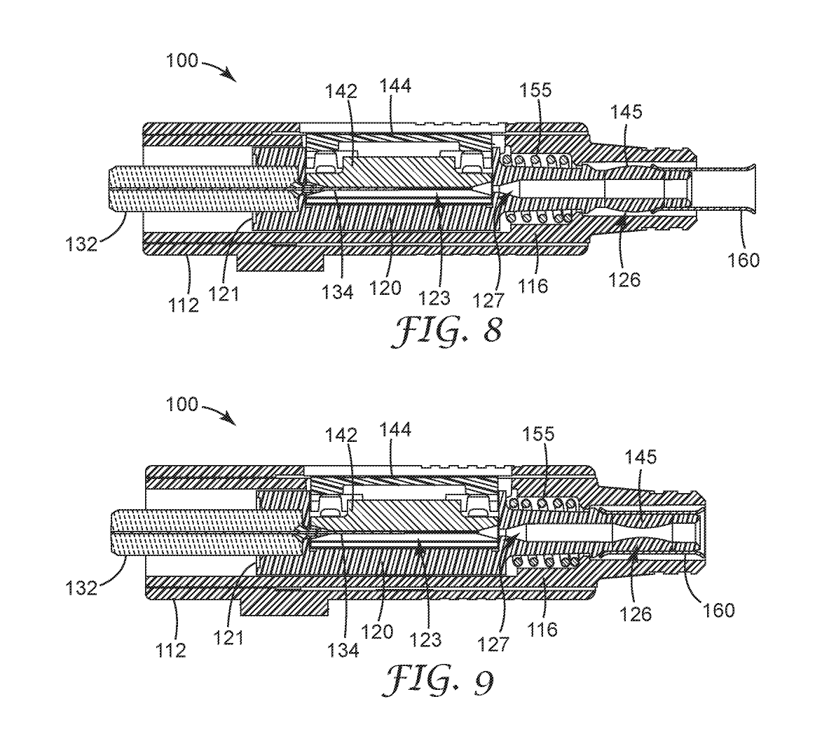

Connector 100 further includes a collar body 120 that is disposed within the connector housing and retained therein. The collar body 120 is a multi-purpose element that can house a fiber stub assembly 130, a mechanical splice 140, and a fiber buffer clamp (such as buffer clamp element 145 shown in FIG. 7). The collar body is configured to have some limited axial movement within backbone 116. For example, the collar body 120 can include a collar or shoulder 125 that can be used as a flange to provide resistance against spring 155 (see e.g. FIGS. 8 and 9), interposed between the collar body and the backbone, when the fiber stub assembly 130 is inserted in a receptacle. Collar body 120 can be formed or molded from a polymer material, although metal and other suitable materials can also be utilized. For example, collar body 120 can comprise an injection-molded, integral material.

In particular, collar body 120 includes a first end portion 121 having an opening to receive and house a fiber stub assembly 130, which includes a ferrule 132 having an optical fiber 134 secured therein. Optical fiber 134 can be constructed in the same manner as any of optical fibers 1-5 described above. Ferrule 132 can be formed from a ceramic, glass, plastic, or metal material to support the optical fiber 134 inserted and secured therein.

Optical fiber 134 can be implemented as a stub fiber and is inserted through the ferrule 132, such that a first fiber stub end slightly protrudes from or is coincident or coplanar with the end face of ferrule 132. Preferably, this first fiber stub end is polished in the factory (e.g., a flat or angle-polish, with or without bevels). A second end of the fiber 134 extends part-way into the interior of the connector 100. This second end of fiber 134 can include a shaped and wavelength selective filter coated end surface, such as end surfaces 10a-10e described previously. This shaped and coated end surface can be utilized to splice a second optical fiber (such as a field fiber) during field termination.

In an alternative aspect, the orientation of the stub fiber can be reversed, such that the shaped and coated second end of the fiber 134 can be located at the ferrule end face, and the first end can extend part-way into the interior of the connector 100.

Fiber 134 can comprise standard single mode or multimode optical fiber, such as SMF 28 (available from Corning Inc.). In an alternative embodiment, fiber 134 additionally includes a carbon coating disposed on the outer clad of the fiber to further protect the glass-based fiber. In an exemplary aspect, fiber 134 is pre-installed and secured (e.g., by epoxy or other adhesive) in the ferrule 132, which is disposed in the first end portion 121 of collar body 120. Ferrule 132 is preferably secured within collar body portion 121 via an epoxy or other suitable adhesive. Preferably, pre-installation of the fiber stub can be performed in the factory.

Collar body 120 further includes a splice element housing portion 123. In the exemplary aspect of FIG. 7, splice element housing portion 123 provides an opening 122 in which a mechanical splice 140 can be inserted and secured in the central cavity of collar body 120. In an exemplary embodiment, mechanical splice 140 comprises a mechanical splice device (also referred to herein as a splice device or splice), such as a 3M™ FIBRLOK™ mechanical fiber optic splice device, available from 3M Company, of Saint Paul, Minn.

For example, commonly owned U.S. Pat. No. 5,159,653, incorporated herein by reference in its entirety, describes an optical fiber splice device (similar to a 3M™ FIBRLOK™ II mechanical fiber optic splice device) that includes a splice element that comprises a sheet of ductile material having a focus hinge that couples two legs, where each of the legs includes a fiber gripping channel (e.g., a V-type (or similar) groove) to optimize clamping forces for conventional glass optical fibers received therein. The ductile material, for example, can be aluminum or anodized aluminum. In addition, a conventional index matching fluid can be preloaded into the V-groove region of the splice element for improved optical connectivity within the splice element. Other conventional mechanical splice devices can also be utilized in accordance with alternative aspects of the present invention and are described in U.S. Pat. Nos. 4,824,197; 5,102,212; 5,138,681; and 5,155,787, each of which is incorporated by reference herein, in their entirety.

Mechanical splice 140 allows a field technician to splice the second end of fiber stub 134 to a second optical fiber at a field installation location. The term “splice,” as utilized herein, should not be construed in a limiting sense since splice 140 can allow removal of a fiber.

In an exemplary embodiment, utilizing a 3M™ FIBRLOK™ II mechanical fiber optic splice device, splice device 140 can include a splice element 142 and an actuating cap 144. In operation, as the cap 144 is moved from an open position to a closed position (e.g. downward in the embodiment depicted in FIG. 7), one or more cam bars located on an interior portion of the cap 144 can slide over splice element legs, urging them toward one another. Preferably, cap 144 can include a cam having a length of about 0.200″. Two fiber ends, (e.g., one end of fiber 134 and one end of the field fiber) are held in place in grooves formed in the splice element and butted against each other and are spliced together in a channel, such as a V-groove channel to provide sufficient optical connection, as the element legs are moved toward one another.

Splice element 142 is mountable in a mounting device or cradle 124 (partially shown in FIG. 7) located in portion 123 of collar body 120. In an exemplary embodiment, cradle 124 is integrally formed in collar body 120, e.g., by molding. Cradle 124 can secure (through e.g., snug or snap-fit) the axial and lateral position of the splice device 140. The mounting device 124 can be configured to hold the splice device 140 such that the splice device 140 cannot be rotated, or easily moved forward or backward once installed. The splice element 142 can be retained by clearance fit below one or more overhanging tabs provided in portion 123. The element receiving cradle 124 is configured to allow the splice element 142 to be inserted when tilted away from the retaining tabs. Once the splice element 142 is fully seated, it is then tilted toward the tabs which brings a portion of the element 142 under the tabs to retain it in a vertical direction. The cap 144 can then be placed over the element 142, as the legs of the cap 144 can extend along the sides of the element 142 and prevent the element from tilting away from the retaining tabs.

Further, collar body 120 includes a buffer clamping portion 126 that can be configured, e.g., by having at least one slot or opening 128, to receive a buffer clamping mechanism, such as a buffer clamp element 145. In an exemplary aspect, the buffer clamping portion 126 is disposed within the interior of the backbone 116 in the fully assembled connector.

According to an exemplary aspect, buffer clamping portion 126 can receive a buffer clamping element 145 that is configured to clamp a standard optical fiber buffer cladding, such as a 900 μm outer diameter buffer cladding, a 250 μm buffer cladding, or a fiber buffer cladding having an outer diameter being larger or smaller.

To activate the particular buffer clamping element 145, connector 100 further includes an actuation sleeve 160 having an opening 161 extending therethrough that is axially slidably received by the outer surface of buffer clamping portion 126. Sleeve 160 can be formed from a polymer or metal material. Preferably, the hardness of the sleeve 160 is greater than the hardness of the material forming the buffer clamping portion 126.

To prevent sharp fiber bends at the connector/fiber interface, a boot 180 can be utilized. In an exemplary aspect, boot 180 includes a conventional tapered tail 182. In an alternative aspect, boot 180 can include a funnel-shaped tail section, which provides a fiber guide to the field technician terminating the fiber and to also provide control of the minimum bend radius to prevent possible signal losses when the fiber is side-loaded. In addition, the boot can be coupled to a back surface of backbone via a rotatable mount. In a further alternative aspect (not shown), the boot can be formed from more than one material to provide a desired bend radius.

The exemplary connector 100 shown in FIGS. 6-9 can provide for straightforward field fiber termination for 250 μm, 900 μm, or non-standard buffer coated optical fiber, without the need for a power source, adhesive, costly installation tools, or field polishing. The exemplary connector can have an overall length of less than two inches. In addition, the connector includes both an integral splice and a buffer clamp internal to the connector backbone.

Alternatively, the optical fibers described herein can be utilized in a different field terminable optical connector. One such alternative field terminable connector is described in U.S. Pat. No. 8,573,859, incorporated by reference herein in its entirety.

The optical devices having a wavelength selective filter coated optical fiber such as described above can be used in PON monitoring. For example, a central office can transmit an optical signal that includes a system signal and a monitoring signal. The signal is split at the cabinet location and distributed to end users, such as single family homes and buildings (e.g., multi-dwelling units). The optical connectors that include the wavelength selective stub fiber can be used to not only for termination (connectorization) of optical fibers for interconnection and cross connection in optical fiber networks inside a fiber distribution unit at an equipment room or a wall mount patch panel, inside pedestals, cross connect cabinets or closures or inside outlets in premises for optical fiber structured cabling applications, but to also provide reflection of the monitoring signal at that particular location. This system can enable the network operator to determine fault location or line degradation for a specific subscriber ID, for example, based on a signal comparison against an initial installation performance state.

Various modifications, equivalent processes, as well as numerous structures to which the present invention may be applicable will be readily apparent to those of skill in the art to which the present invention is directed upon review of the present specification.

1. An article comprising:
an optical fiber having a first end with a first end surface having a deposited coating only on a portion thereof.

2. An article comprising:
an optical fiber having a frusto-conical or tronconic first end with a first end surface having a deposited coating only on a portion thereof.

3. (canceled)

4. The article of claim 1, wherein the deposited coating comprises a wavelength selective multilayer thin film filter coating.

5. The article of claim 1, wherein the first end surface comprises a continuous frusto-conical or tronconical shape having a tip surface and a radial side surface having an angle of greater than 10 degrees and less than 30 degrees with respect to an optical axis of the fiber.

6. The article of claim 1, wherein the first end surface comprises a frusto-conical or tronconical shape having a tip surface and a plurality of radial side surfaces each having an angle of greater than 15 degrees and less than 25 degrees with respect to an optical axis of the fiber.

7. The article of claim 5 wherein the radial side surface is free of the deposited coating.

8. The article of claim 6 wherein the radial side surfaces are free of the deposited coating.

9. The article of claim 1, wherein the deposited coating is substantially uniform on the tip portion of the first end surface.

10. The article of claim 1, wherein the deposited coating is configured to pass light having a wavelength of from about 1260 nm to about 1620 nm and reflect light having a wavelength of about 1640 nm to about 1690 nm.

11. An optical connector comprising the article of claim 1.

12. The optical connector of claim 11, comprising a ferrule that holds the optical fiber.

13. The optical connector of claim 12, further comprising a mechanical splice device, wherein the first end of the optical fiber mates with a field fiber in a splice element of the mechanical splice device.

14-16. (canceled)

17. A passive optical network (PON) comprising the optical connector, of claim 11.

18. The PON of claim 17, wherein the deposited coating is configured to reflect a selected wavelength of light back to a central office of the PON to provide monitoring.

19. The article of claim 2, wherein the deposited coating comprises a wavelength selective multilayer thin film filter coating.

20. The article of claim 2, wherein the first end surface comprises a continuous frusto-conical or tronconical shape having a tip surface and a radial side surface having an angle of greater than 10 degrees and less than 30 degrees with respect to an optical axis of the fiber.

21. The article of claim 2, wherein the deposited coating is substantially uniform on the tip portion of the first end surface.

22. The article of claim 2, wherein the deposited coating is configured to pass light having a wavelength of from about 1260 nm to about 1620 nm and reflect light having a wavelength of about 1640 nm to about 1690 nm.

23. An optical connector comprising the article of claim 2.
